(19) United States
(12) Patent Application Publication
(10) Pub. No.: US 2024/0020575 A1
(43) Pub. Date: Jan. 18, 2024

(54) INFORMATION PROCESSING DEVICE, INFORMATION PROCESSING METHOD, AND RECORDING MEDIUM

(71) Applicant: NEC Corporation, Minato-ku, Tokyo (JP)

(72) Inventors: Yuta HATAKEYAMA, Tokyo (JP); Yuzuru OKAJIMA, Tokyo (JP)

(73) Assignee: NEC Corporation, Minato-ku, Tokyo (JP)

(21) Appl. No.: 18/037,298

(22) PCT Filed: Nov. 30, 2020
(86) PCT No.: PCT/JP2020/044483

§ 371 Date: May 16, 2023

(51) Int. Cl. G06N 20/00

(52) U.S. Cl. CPC G06N 20/00

(57) ABSTRACT

In an information processing device, an input means accepts training examples formed by features. A label means assigns labels to the training examples. An error calculation means generates one or more student models using the training examples to which the labels are assigned, and calculates errors between predictions of the one or more student models and the labels. An error prediction model generation means generates an error prediction model which is a model for predicting the errors. An output means outputs each example for which the error is predicted to be significant based on the error prediction model.

### TECHNICAL FIELD

The present disclosure relates to a technique for improving accuracy of a machine learning model.

### BACKGROUND ART

Active learning is known as a technique to improve accuracy of a machine learning model through supervised learning. The active learning is a technique to improve the accuracy of the machine learning model by re-training the machine learning model using examples which cannot be predicted well by a current machine learning model, to which a teacher (oracle) assigns labels and generates examples.

The active learning method basically considers “examples in which a student model outputs ambiguous predictions or contradictory predictions” as examples which cannot be predicted well, and re-trains the machine learning model by assigning labels to the examples. Uncertainty sampling and query-by-committee (QBC) are known as examples of the active learning. The uncertainty sampling is a method which assigns the labels to the examples which are close to decision boundary created by the student model, while the query-by-committee is a method which assigns the labels to the examples for which a plurality of student models output contradictory answers.

Non-Patent Document 1 also proposes a method which combines a GAN (Generative Adversarial Network) and the active learning. This method uses the GAN to create artificial examples in which a classifier to be a target outputs ambiguous predictions.

### PRECEDING TECHNICAL REFERENCES

### Patent Document

Non-Patent Document 1: Kong, Q., Tong, B., Klinkigt, M., Watanabe, Y., Akira, N., and Murakami, T, “Active generative adversarial network for image classification”, In Association for the Advancement of Artificial Intelligence, 2019, Airxiv: https://arxiv.org/abs/1906.07133

### SUMMARY

### Problem to be Solved by the Invention

However, a fact that a student model outputs an ambiguous prediction is not equal to a fact that the student model makes a wrong prediction. For example, the student model may make the wrong prediction even if an example is far from a decision boundary. Also, even if the student model predicts with a confidence level of almost “1”, the prediction may actually be wrong. This is especially true when the prediction of the student model is not reliable. Therefore, it is difficult in the above active learning method to efficiently find examples which significantly improve prediction accuracy.

It is one object of the present disclosure to efficiently find the examples which significantly improve the prediction accuracy.

### Means for Solving the Problem

According to an example aspect of the present disclosure, there is provided an information processing device including:
an input means configured to accept training examples formed by features;
a label means configured to assign labels to the training examples;
an error calculation means configured to generate one or more student models using the training examples to which the labels are assigned, and calculate errors between predictions of the one or more student models and the labels;
an error prediction model generation means configured to generate an error prediction model which is a model for predicting the errors; and
an output means configured to output each example for which the error is predicted to be significant based on the error prediction model.

According to another example aspect of the present disclosure, there is provided an information processing method including:
accepting training examples formed by features;
assigning labels to the training examples;
generating one or more student models using the training examples to which the labels are assigned, and calculating errors between predictions of the one or more student models and the labels;
generating an error prediction model which is a model for predicting the errors; and
outputting each example for which the error is predicted to be significant based on the error prediction model.

According to a further example aspect of the present disclosure, there is provided a recording medium storing a program, the program causing a computer to perform a process including:
accepting training examples formed by features;
assigning labels to the training examples;
generating one or more student models using the training examples to which the labels are assigned, and calculating errors between predictions of the one or more student models and the labels;
generating an error prediction model which is a model for predicting the errors; and
outputting each example for which the error is predicted to be significant based on the error prediction model.

### BRIEF DESCRIPTION OF THE DRAWINGS

FIG. 1 is a diagram conceptually illustrating a method of example embodiments.

FIG. 2 is a diagram conceptually illustrating an information processing device of the example embodiments.

FIG. 3 is a diagram illustrating a hardware configuration of the information processing device of a first example embodiment.

FIG. 4 is a diagram illustrating a functional configuration of the information processing device of the first example embodiment.

FIG. 5 schematically illustrates a method for generating an error prediction model.

FIG. 6 illustrates an example of a result from performing a Gaussian process regression based on a plurality of observation points of prediction errors.

FIG. 7 is a diagram for explaining overfitting of prediction errors.

FIG. 8 illustrates a specific example for generating error calculation examples from training examples.

FIG. 9 is a flowchart of a process by the information processing device of the first example embodiment.

FIG. 10 is a diagram illustrating a functional configuration of an information processing device according to a second example embodiment.

FIG. 11 is a flowchart of a process of the information processing device according to the second example embodiment.

### EXAMPLE EMBODIMENTS

In the following, example embodiments will be described with reference to the accompanying drawings.

### First Example Embodiment

[Basic Principle]

In known active learning methods, labels are assigned and re-training is performed for examples for which a student model outputs an ambiguous prediction. However, as mentioned above, a fact that a student model outputs an ambiguous prediction is not equal to a fact that the student model makes a wrong prediction, and the prediction output by the student model with a confidence level “1” may be wrong. This is due to the fact that the examples used for re-training are selected based on the student model only. That is, since predictions of the student model are evaluated based on the confidence level and a probability output by the student model itself, the pros and cons of the examples selected for re-training depend on an actual accuracy of the student model.

Therefore, in example embodiments, the teacher model which can be regarded as outputting absolutely correct predictions is prepared, and predictions of the student model are evaluated by comparing the predictions with those of the teacher model. By this comparison, in a case where the predictions of the student model are close to those of the teacher model, then the predictions of the student model are considered to be reliable. On the other hand, in a case where the predictions of the student model are far from the predictions of the teacher model, the predictions of the student model are considered suspect. Therefore, by selecting, as examples for re-training, examples in which each error between the prediction of the student model and the prediction of the teacher model is to be significant, it is possible to acquire examples which contribute significantly to improving accuracy.

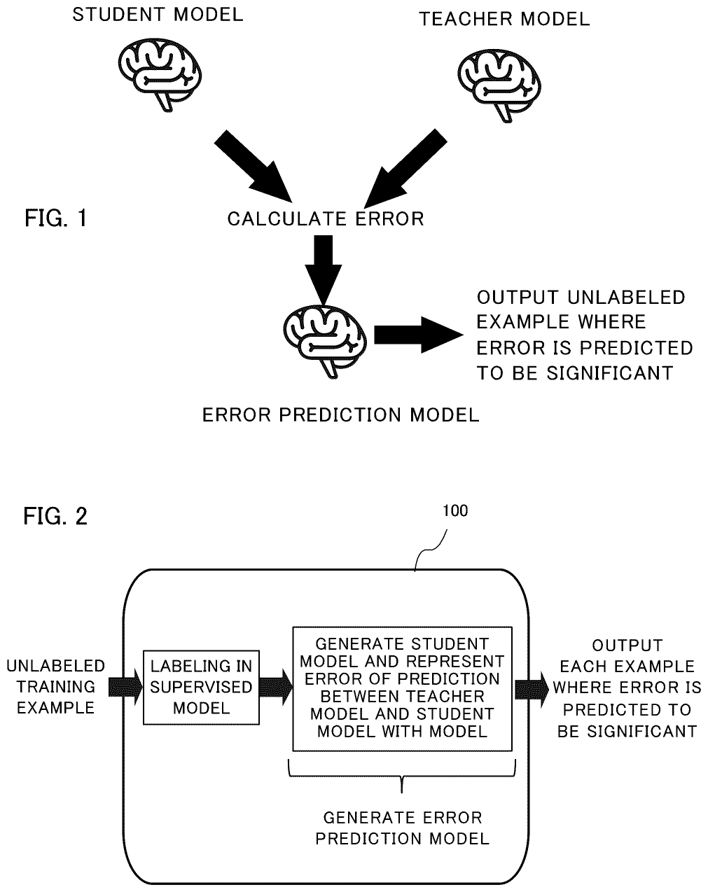

FIG. 1 conceptually illustrates a method in the present example embodiments. As described above, in addition to the student model to be trained, the teacher model is prepared, which can be regarded as outputting absolutely correct predictions as described above. First, for a plurality of training examples, predictions are made by the student model and the teacher model respectively, and errors in the predictions are calculated. Next, based on the calculated errors, a model which estimates respective errors in the predictions of the student model and the teacher model (hereinafter referred to as an “error prediction model”) is generated. The error prediction model is then used to generate a re-training model. This error prediction model is then used to select examples for re-training. Accordingly, it becomes possible to select examples which contribute to improving the accuracy of the student model.

[Overall Configuration of an Information Processing Device]

FIG. 2 conceptually illustrates an information processing device in the present example embodiments. A plurality of unlabeled training examples are input to an information processing device 100. The information processing device 100 first assigns labels to the input unlabeled training examples with the teacher model described above. These labels correspond to the predictions made by the teacher model. Next, the information processing device 100 generates a student model using the labeled training examples. Next, the information processing device 100 makes predictions with the generated student model, and generates an error prediction model which indicates each error between the labels assigned by the teacher model and the predictions of the student model. The error prediction model thus generated is a model which indicates, for each example, the error between the prediction of the student model and the prediction of the teacher model for that example. The information processing device 100 uses the error prediction model to output the examples for which the errors are expected to be significant. By re-training the student model by assigning the labels to these examples, the accuracy of the student model is expected to be improved.

[Hardware Configuration]

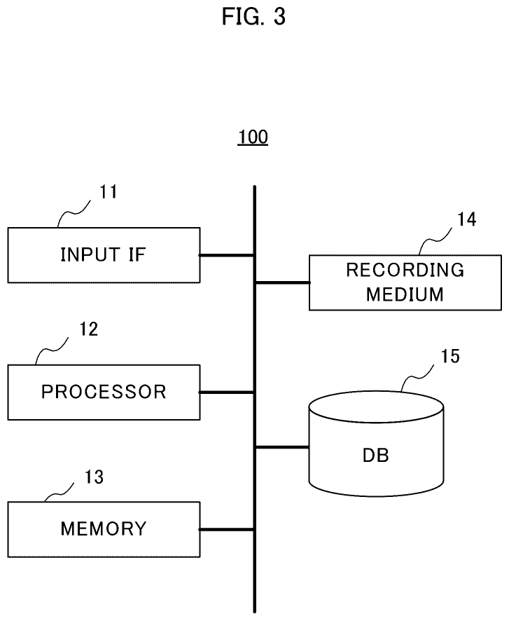

FIG. 3 is a block diagram illustrating a hardware configuration of the information processing device 100 of a first example embodiment. As illustrated in the figure, the information processing device 100 includes an input IF (InterFace) 11, a processor 12, a memory 13, a recording medium 14, and a database (DB) 15.

The input IF 11 inputs and outputs data. Specifically, the input IF 11 acquires training examples formed by features, and outputs each example which is predicted to have a significant error based on the error prediction model.

The processor 12 is a computer such as a central processing unit (CPU) or a graphics processing unit (GPU), and controls the entire information processing device 100 by executing a program prepared in advance. In particular, the processor 12 performs an example output process which outputs each example predicted to have the significant error based on the error prediction model.

The memory 13 consists of a ROM (Read Only Memory), a RAM (Random Access Memory), and the like. The memory 13 stores various programs executed by the processor 12. The memory 13 is also used as a working memory during executions of various processes by the processor 12.

The recording medium 14 is a non-volatile and non-transitory recording medium, such as a disk-shaped recording medium or semiconductor memory, and is removable from the information processing device 100. The recording medium 14 records various programs to be executed by the processor 12.

The DB 15 stores the training examples which are input from the input IF 11. The DB 15 also stores information on the error prediction model generated using the training examples.

[Functional Configuration]

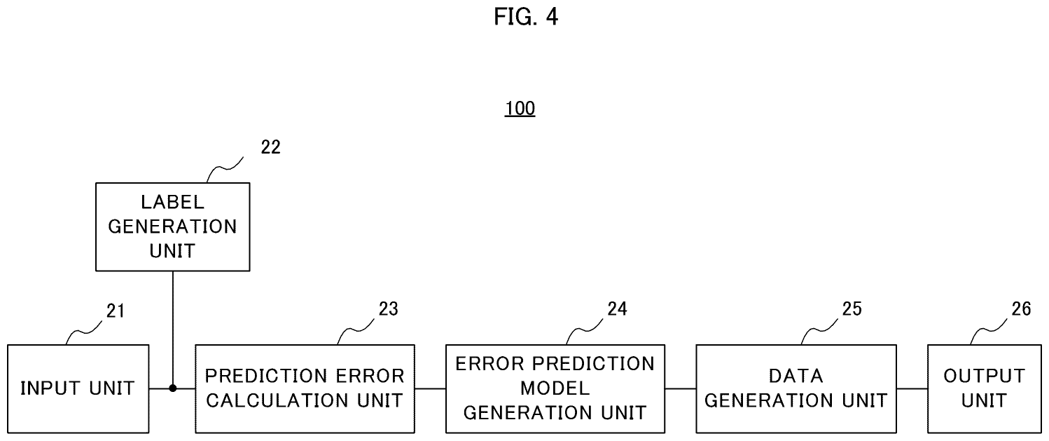

FIG. 4 illustrates a block diagram of a functional configuration of the information processing device 100. The information processing device 100 includes an input unit 21, a label generation unit 22, a prediction error calculation unit 23, an error prediction model generation unit 24, a data generation unit 25, and an output unit 26.

The unlabeled training examples which are used to train the student model and the trained teacher model are input to the input unit 21. The training example is formed by multi-dimensional features. The input unit 21 outputs the unlabeled training examples and the trained teacher model to the label generation unit 22. The input unit 21 also outputs the unlabeled training examples to the prediction error calculation unit 23.

The label generation unit 22 generates labels for the input unlabeled training examples using the trained teacher model, and outputs the labels to the prediction error calculation unit 23. Note that these labels correspond to respective predictions of the teacher model for the input unlabeled training examples.

The prediction error calculation unit 23 acquires the unlabeled training examples from the input unit 21, and also acquires the labels assigned respectively to the training examples from the label generation unit 22. As a result, the labeled training examples are provided to the prediction error calculation unit 23. The prediction error calculation unit 23 trains the student model using these labeled training examples, and generates the trained student model.

Next, the prediction error calculation unit 23 makes a prediction using the generated student model. The prediction error calculation unit 23 then calculates an error between the prediction by the student model and the label input from the label generation unit 22, that is, the error between the prediction by the student model and the prediction by the teacher model (hereinafter referred to as a “prediction error”). The prediction error is calculated and output to the error prediction model generation unit 24. As will be explained in more detail later, different training examples from the examples used to train the student model are used in the calculation of the prediction error.

The error prediction model generation unit 24 acquires prediction errors for a plurality of examples from the prediction error calculation unit 23, and generates the error prediction model. The error prediction model is a model which estimates the prediction errors between the teacher model and the student model for each of the examples, as described above. Here, the error prediction model generation unit 24 generates a differentiable model as the error prediction model. This is because by using the differentiable model as the error prediction model, it is possible to efficiently search for examples with significant errors even in a case where the student model is a non-differentiable model. In a preferable example, a regression model is used as the error prediction model. For instance, even in a case where the student model is the non-differentiable model such as a decision tree, when a differentiable regression model is used as the error prediction model, it is possible to efficiently find an example where the prediction error is to be significant by calculating a slope of the regression model.

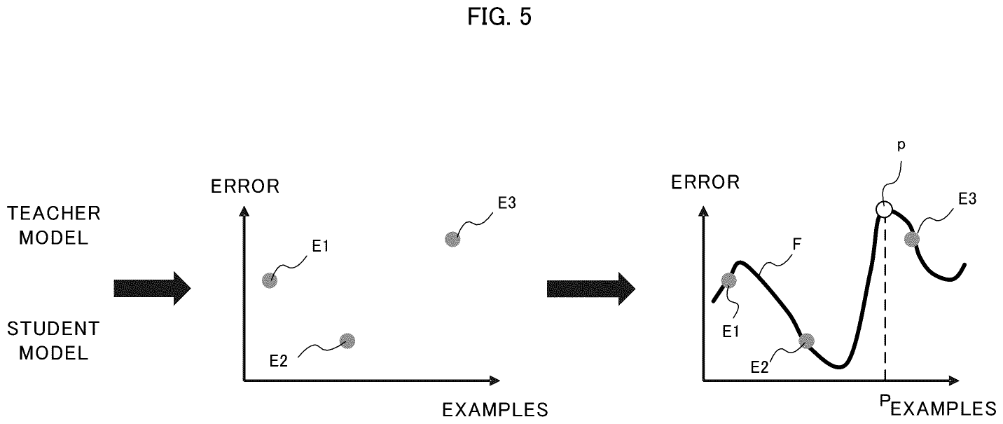

FIG. 5 schematically illustrates a method for generating the error prediction model. It is assumed that prediction errors E1 to E3 of the teacher model and the student model are obtained for the plurality of examples. The error prediction model generation unit 24 plots the prediction errors E1 to E3 in a region where a horizontal axis indicates the examples and the vertical axis indicates the prediction error, as depicted in FIG. 5. Each position of the examples on the horizontal axis is determined based on features for each of the examples. The higher up the position of a point on the vertical axis, the higher the value of the prediction error. As illustrated in the figure, the prediction errors for the examples are discrete, and the error prediction model generation unit 24 generates a differentiable function through the prediction errors E1 to E3 as an error prediction model F.

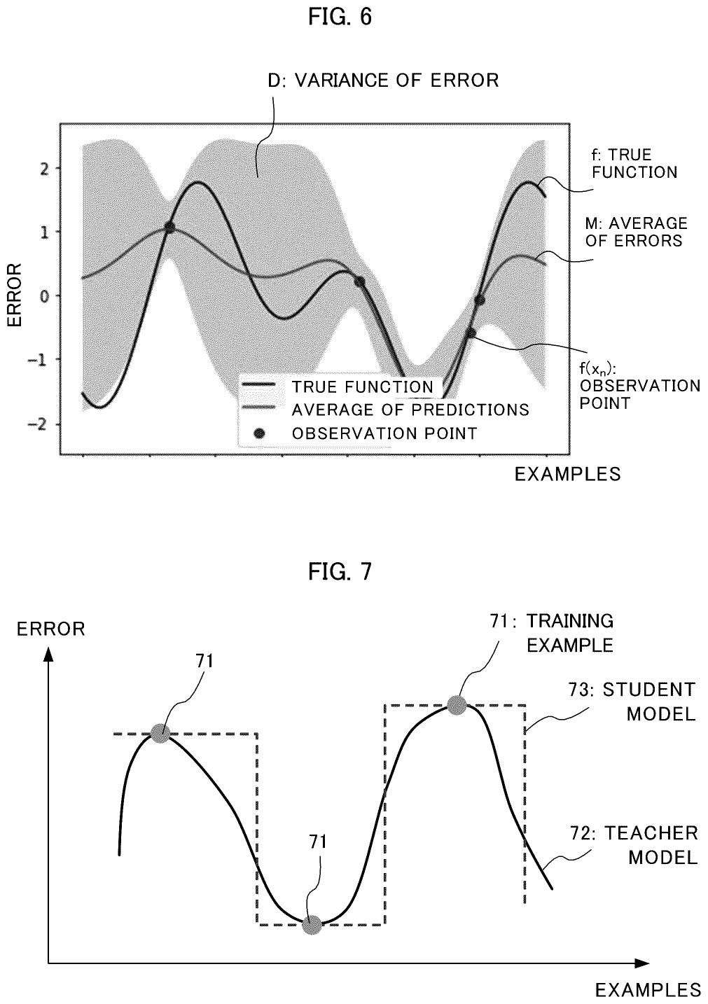

As a preferable example, an example is illustrated to generate the error prediction model using a Gaussian process regression. The Gaussian process regression is a method for predicting a continuous function f from observation points f(x₁), . . . , f (xₙ), and more precisely is a method for acquiring a probability distribution of the function f from discrete observation points in a form of a Gaussian distribution. FIG. 6 illustrates an example of a result from the Gaussian process regression based on a plurality of observation points f(xₙ) of the prediction errors output by the prediction error calculation unit 23. The graph f illustrates a true function and is actually unknown. As the result of the Gaussian process regression based on the observation points f(xₙ), an average of errors depicted in a graph M and a variance of the errors depicted in a gray area D are acquired. That is, the error prediction model generation unit 24 generates the graph M illustrating the average of the errors and the area D representing the variance of the errors, as the error prediction model. Thus, since the Gaussian process regression outputs a differentiable (that is, continuous) average and variance, a function incorporating the average and variance is also differentiable, and an optimization is facilitated. In a preferable example, the error prediction model generation unit 24 generates the error prediction model using the Gaussian process regression with the prediction errors between the student model and the teacher model as observation points. The error prediction model generation unit 24 outputs the generated error prediction model to the data generation unit 25.

The data generation unit 25 generates examples which complement locations with significant errors based on the error prediction model, and outputs the examples to the output unit 26. For instance, in a case where a function F depicted in FIG. 5 is generated as the error prediction model, the data generation unit 25 generates an example P corresponding to a point p where the error is great on the function F. Specifically, in a case where a training example corresponding to the example P exists among the plurality of training examples input to the input unit 21, the data generation unit 25 outputs that training example. Moreover, in a case where there is no training example corresponding to the example P, the data generation unit 25 artificially generates features corresponding to the example P based on features of a training example close to the example P, and outputs the generated features as an artificial example P. Note that based on the error prediction model, the data generation unit 25 may output the example corresponding to the point where the error is maximum, output examples corresponding to a predetermined number of points from which the errors are greater, or output examples corresponding to points for which the errors are equal to or greater than a predetermined threshold value.

As illustrated in FIG. 6, in a case where the error prediction model generation unit 24 uses the Gaussian process regression and outputs an average M and a variance D of the errors as the error prediction model, the data generation unit 25 outputs an example corresponding to a point where at least one of the average M and the variance D of the errors is great, as an example where the error is expected to be significant. Specifically, the data generation unit 25 may output examples corresponding to a certain number of points where the average M or the variance D of the errors is close to a maximum value, or examples corresponding to a plurality of points where the average M or the variance D of the errors is greater than a predetermined threshold value. Alternatively, the data generation unit 25 may predict a maximum point of the true function f by a Bayesian optimization using the Gaussian process regression or other methods, and output an example corresponding to the maximum point as the example for which the error is predicted to be significant.

The output unit 26 outputs the examples input from the data generation unit 25 as examples for which the errors are expected to be significant. The output examples are then used to re-train the student model. In detail, the labels may be assigned to the output examples using the teacher model used in the label generation unit 22, and the output examples may be used to train the student model.

Alternatively, the labels may be assigned to the output examples using a different teacher model from the teacher model used in the label generation unit 22 or may be assigned manually.

[Overfitting of the Prediction Error]

Next, the overfitting of the prediction error will be described. In the information processing device 100 described above, the labels are assigned to the unlabeled training examples input from input unit 21 using the teacher model to generate the labeled training examples, and the labeled training examples are used to train the student model. Therefore, in a case where the prediction error calculation unit 23 calculates prediction errors of the teacher model and the student model using the same training examples used to train the student model, a prediction of the teacher model and a prediction of the student model for each example are consistent, so the prediction error becomes zero. Accordingly, in a case where the error prediction model is generated by the error prediction generation unit 24, the error prediction model indicates a zero error at all points corresponding to the training examples. In other words, the overfitting occurs in the prediction itself of the prediction error using the error prediction model, and an error smaller than an original error is predicted. This is called “overfitting of the prediction error.

FIG. 7 illustrates the overfitting of the prediction errors. In FIG. 7, it is assumed that a plurality of points 71 represent the training examples and a graph 72 with a solid line represents the teacher model. Since the student model is trained using the labels assigned by the teacher model to the training examples as teacher data, the student model is trained so that the prediction errors with respect to the teacher model is zero at locations of training examples 71, as depicted in a graph 73 with a dashed line. Therefore, in a case of calculating each prediction error between the teacher model and the student model using the same training examples used to train the student model, all prediction errors used to generate the error prediction model are zero, and it is unable to generate an error prediction model with generalizability.

Therefore, in the present first example embodiment, the prediction error used to generate the error prediction model is calculated using examples different from the training examples used to train the student model. That is, the training examples used to train the student model (hereinafter referred to as “student model training examples”) are different from the examples used to calculate the prediction error used to generate the error prediction model (hereinafter referred to as “error calculation examples”). The following examples are different from the student model training examples. In the following, a method will be described for generating the error calculation examples which differ from the student model training examples.

(Method 1) Generate Error Calculation Examples by Oversampling

Oversampling is a method for artificially generating examples, that is, SMOTE, MUNGE, or the like. Specifically, all previously prepared training examples are used as the student model training examples to train the student model. New unlabeled examples x′ are created from the training examples by oversampling, and are used as examples for an error calculation. After that, using new unlabeled examples x′, each prediction error between the teacher model and the student model is calculated, for instance, by the following expression.

Prediction error=|Teacher·predict(x′)−Student·predict(x′)|

(Method 2) Generate Examples for the Error Calculation by Dividing the Training Examples.

In a method 2, the training examples labeled by the teacher model are divided, and some of the divided training examples are used as the training examples for the student model to train the student model. Moreover, the remaining training examples are used as the error calculation examples to calculate respective prediction errors of the teacher model and the student model.

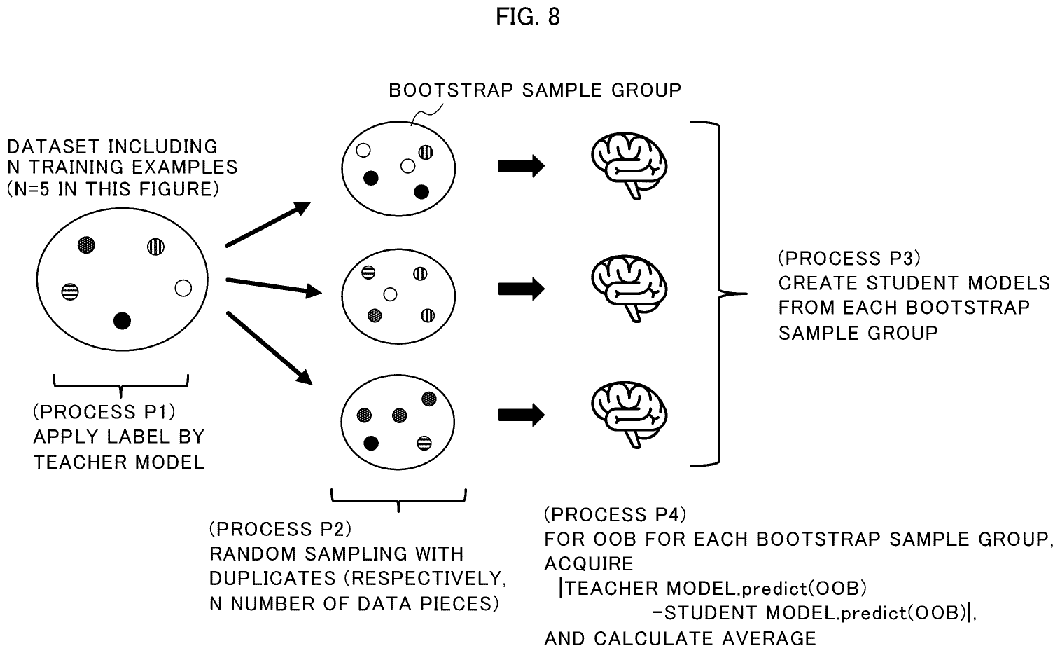

FIG. 8 illustrates a specific example for generating examples for the error calculation by dividing the training examples according to the method 2. As illustrated in the figure, it assumed that a data set including N training examples (N=5 in the example in FIG. 8) is input from the input unit 21. First, the label generation unit 22 assigns labels to all data of the training examples using the teacher model (process P1).

Next, the prediction error calculation unit 23 performs random sampling with duplicates (bootstrap sampling) from the training examples to generate M bootstrap sample groups (M=3 in the example in FIG. 8) (process P2). The number of data pieces in each of the bootstrap sample groups is N. After that, the prediction error calculation unit 23 creates the student model using each of the bootstrap sample groups (process P3). That is, each of the bootstrap sample groups is used as the student model training examples. By these processes, M student models are generated.

Since each of the bootstrap sample groups is generated by the random sampling with duplicates from the training examples, there are samples which are included in the training examples but not selected for the bootstrap sample groups. These are called Out-Of-Bag (OOB) samples. The OOB samples are not used to generate the student model because these samples are not included in the bootstrap sample groups. Therefore, the prediction error calculation unit 23 uses the OOB samples of each of the bootstrap sample groups as examples for the error calculation, and calculates the prediction error between the teacher model and the student model for each of the OOB samples. In detail, regarding the OOB examples for each of bootstrap sample groups, the prediction error calculation unit 23 acquires predictions made by the student model corresponding to that bootstrap sample group and the teacher model. After that, the prediction error calculation unit 23 calculates the prediction errors for each of the M bootstrap sample groups using the following expression, and outputs the average of the prediction errors to the error prediction model generation unit 24 as the prediction error (process P4).

Prediction error=|Teacher·predict(OOB)−Student·predict(OOB)|

In this way, the prediction errors between the teacher model and the student model can be calculated using the examples which differ from the training examples used to generate the student model.

(Method 3) Acquire Other Training Examples

In a method 3, all training examples input in the input unit 21 are used as the student model training examples to generate the student model. On the other hand, unlabeled examples which differ from the training examples are separately acquired and used as examples for the error calculation.

[Processes by the Information Processing Device]

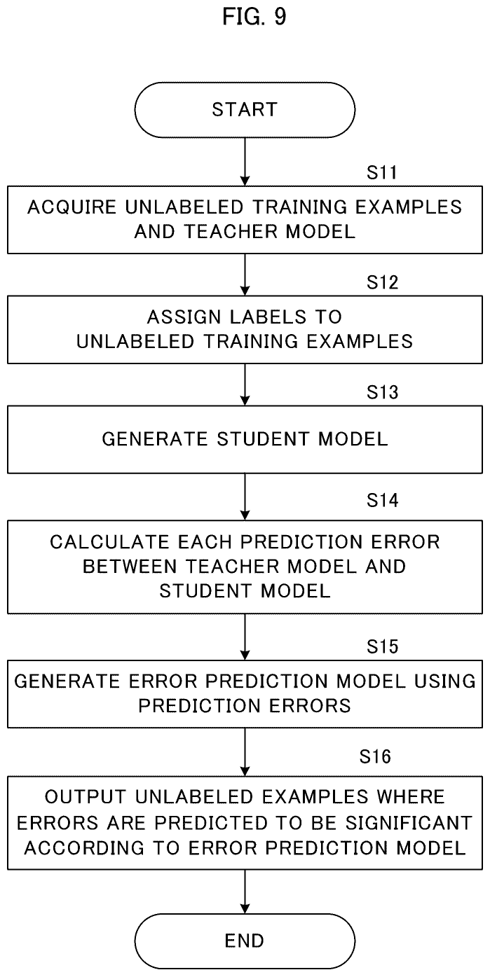

Next, a process for outputting examples which are predicted to have significant errors by the information processing device 100 (hereinafter also referred to as an “example output process”) will be described. FIG. 9 illustrates a flowchart of the example output process. FIG. 9 is a flowchart of the example output process. This process is realized by the processor 12 depicted in FIG. 3, which executes a program prepared in advance and operates as each of the elements depicted in FIG. 4.

First, the input unit 21 acquires the unlabeled training examples and the teacher model (step S11). Next, the label generation unit 22 assigns labels to the unlabeled training examples using the teacher model (step S12). Subsequently, the prediction error calculation unit 23 generates the student model using the training examples which have been labeled in step S12 (step S13).

Next, the prediction error calculation unit 23 calculates each prediction error between the teacher model and the student model (step S14). At this time, as described above, the prediction error calculation unit 23 calculates the prediction errors between the teacher model and the student model for the error calculation examples different from the student model training examples which are used to generate the student model in step S13.

Next, the error prediction model generation unit 24 generates a differentiable error prediction model using the calculated prediction errors, by the Gaussian process regression, for instance (step S15). After that, the data generation unit 25 uses the error prediction model to generate the unlabeled examples for which the errors are predicted to be significant, and the output unit 26 outputs the generated examples (step S16). The process is then terminated.

[Modifications]

Next, variations of the first example embodiment will be described. The following variations can be combined as appropriate and applied to the first example embodiment.

(Modification 1)

In the above example embodiment, the label generation unit 22 assigns labels to unlabeled training examples input to the input unit 21 using the teacher model which has been prepared in advance and has been trained. Instead, in a case where the labeled training examples are input to the input unit 21, the label generation unit 22 may first generate the teacher model using the labeled training examples. Instead of assigning labels using the teacher model, the label generation unit 22 may manually assign the labels. In the above example embodiment, the prediction error calculation unit 23 generates the student model using the training examples to which the label generation unit 22 has assigned the labels; alternatively, the prediction error calculation unit 23 may acquire the trained student model prepared in advance.

(Modification 2)

In the above example embodiment, the output unit 26 outputs each unlabeled example for which an error is expected to be significant, but a label assigning unit may be provided at a later stage of the output unit 26. In this way, the label assigning unit assigns the labels to the unlabeled examples output by the output unit 26 to generate the labeled training examples which can be used for re-training the student model. Note that in this case, the label assigning unit may assign the labels using the teacher model used by the label generation unit 22, may assign the labels using a different teacher model than that used by the label generation unit 22, or may assign the labels manually or the like.

### Second Example Embodiment

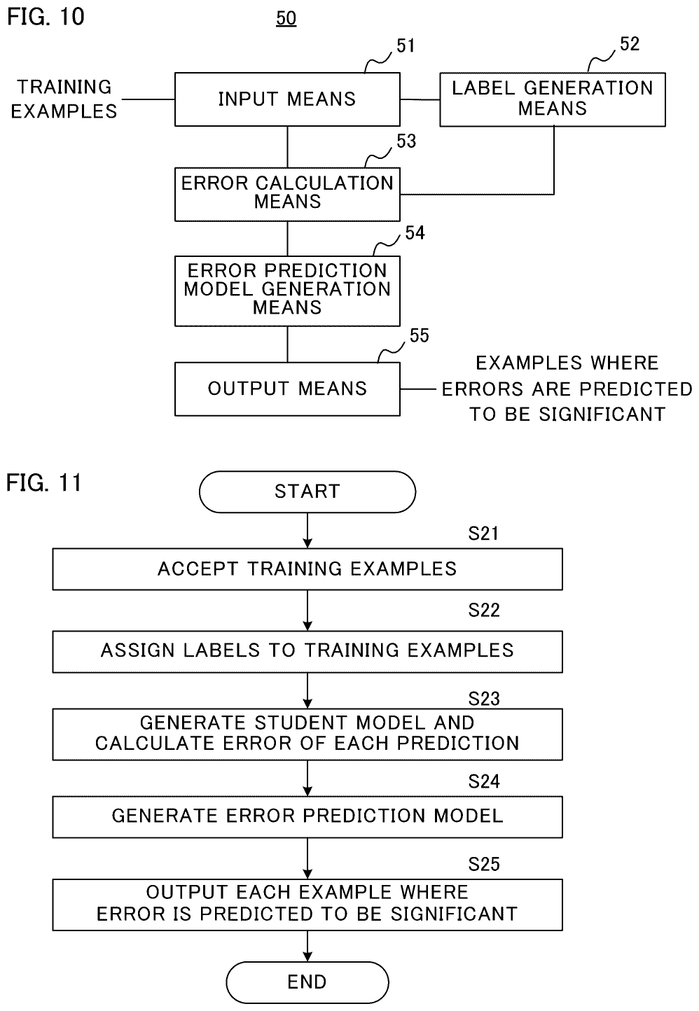

FIG. 10 is a block diagram illustrating a functional configuration of an information processing device 50 of a second example embodiment. The information processing device 50 has an input means 51, a label generation means 52, an error calculation means 53, an error prediction model generation means 54, and an output means 55. The input means 51 accepts training examples each formed by features. The label generation means 52 assigns labels to the training examples. The error calculation means 53 generates one or more student models using the labeled training examples, and calculates respective errors between predictions by the student models and the labels. The error prediction model generation means 54 generates an error prediction model which is a model for predicting errors. The output means 55 outputs examples for which the errors are predicted to be significant based on the error prediction model.

FIG. 11 is a flowchart of the process by the information processing device 50 of the second example embodiment. The input means 51 accepts the training examples formed by the features (step S21). The label generation means 52 assigns the labels to the training examples (step S22). The error calculation means 53 generates one or more student models using the labeled training examples, and calculates errors between respective predictions by the student models and the labels (step S23). The error prediction model generation means 54 generates the error prediction model which is a model for predicting each error (step S24). The output means 55 outputs examples for which errors are predicted to be significant based on the error prediction model (step S25).

According to the information processing device 50 of the second example embodiment, the error prediction model is generated using the training examples, and the examples for which the errors are expected to be significant are output based on the error prediction model. Therefore, by re-training the student model using the output examples, it is possible to efficiently improve the accuracy of the student model.

A part or all of the example embodiments described above may also be described as the following supplementary notes, but not limited thereto.

(Supplementary Note 1)

An information processing device comprising:
an input means configured to accept training examples formed by features;
a label means configured to assign labels to the training examples;
an error calculation means configured to generate one or more student models using the training examples to which the labels are assigned, and calculate errors between predictions of the one or more student models and the labels;
an error prediction model generation means configured to generate an error prediction model which is a model for predicting the errors; and
an output means configured to output each example for which the error is predicted to be significant based on the error prediction model.

(Supplementary Note 2)

The information processing device according to supplementary note 1, wherein the error prediction model generation means generates a differentiable error prediction model based on the errors between the predictions of the one or more student models and the labels regarding a plurality of the training examples.

(Supplementary Note 3)

The information processing device according to supplementary note 1 or 2, wherein
the error prediction model is a regression model, and
the output means predicts the errors of the examples based on a slope of the regression model.

(Supplementary Note 4)

The information processing device according to supplementary note 1 or 2, wherein
the error prediction model is a model which outputs a differentiable average and variance of the errors; and
the output means outputs each example for which the error is predicted to be significant based on at least one of the differentiable average and variance.

(Supplementary Note 5)

The information processing device according to any one of supplementary notes 1 to 4, wherein
the label generation means assigns the labels to the training examples by using a teacher model which is generated using the training examples, and
the error calculation means calculates the errors between the labels corresponding to predictions of the teacher model and the predictions of the one or more student models.

(Supplementary Note 6)

The information processing device according to any one of supplementary notes 1 to 5, wherein the error calculation means generates the one or more student models using examples corresponding to at least a part of the training examples, and calculates the errors using examples different from the examples used to generate the one or more student models.

(Supplementary Note 7)

The information processing device according to any one of supplementary notes 1 to 5, wherein the error calculation means generates a plurality of sampling groups by random sampling with duplicates from the training examples, generates the one or more student models using each of the sampling groups, calculates, for each of the one or more student models, the errors with respect to data which are included in the training examples but not included in the sampling group, and calculates an average of the errors calculated for the one or more student models.

(Supplementary Note 8)

An information processing method comprising:
accepting training examples formed by features;
assigning labels to the training examples;
generating one or more student models using the training examples to which the labels are assigned, and calculating errors between predictions of the one or more student models and the labels;
generating an error prediction model which is a model for predicting the errors; and outputting each example for which the error is predicted to be significant based on the error prediction model.

(Supplementary Note 9)

A recording medium storing a program, the program causing a computer to perform a process comprising:
accepting training examples formed by features;
assigning labels to the training examples;
generating one or more student models using the training examples to which the labels are assigned, and calculating errors between predictions of the one or more student models and the labels;
generating an error prediction model which is a model for predicting the errors; and
outputting each example for which the error is predicted to be significant based on the error prediction model.

While the disclosure has been described with reference to the example embodiments and examples, the disclosure is not limited to the above example embodiments and examples. It will be understood by those of ordinary skill in the art that various changes in form and details may be made therein without departing from the spirit and scope of the present disclosure as defined by the claims.

### DESCRIPTION OF SYMBOLS

11 Input IF
12 Processor
13 Memory
14 Recording medium
15 Database
21 Input unit
22 Label generation unit
23 Prediction error calculation unit
24 Error prediction model generation unit
25 Data generation unit
26 Output unit
100 Information processing device

What is claimed is:

1. An information processing device comprising:
a memory storing instructions; and
one or more processors configured to execute the instructions to:
accept training examples formed by features;
assign labels to the training examples;
generate one or more student models using the training examples to which the labels are assigned, and calculate errors between predictions of the one or more student models and the labels;
generate an error prediction model which is a model for predicting the errors; and
output each example for which the error is predicted to be significant based on the error prediction model.

2. The information processing device according to claim 1, wherein the processor generates a differentiable error prediction model based on the errors between the predictions of the one or more student models and the labels regarding a plurality of the training examples.

3. The information processing device according to claim 1, wherein
the error prediction model is a regression model, and
the processor predicts the errors of the examples based on a slope of the regression model.

4. The information processing device according to claim 1, wherein
the error prediction model is a model which outputs a differentiable average and variance of the errors; and
the processor outputs each example for which the error is predicted to be significant based on at least one of the differentiable average and variance.

5. The information processing device according to claim 1, wherein
the processor assigns the labels to the training examples by using a teacher model which is generated using the training examples, and
the processor calculates the errors between the labels corresponding to predictions of the teacher model and the predictions of the one or more student models.

6. The information processing device according to claim 1, wherein the processor generates the one or more student models using examples corresponding to at least a part of the training examples, and calculates the errors using examples different from the examples used to generate the one or more student models.

7. The information processing device according to claim 1, wherein the processor generates a plurality of sampling groups by random sampling with duplicates from the training examples, generates the one or more student models using each of the sampling groups, calculates, for each of the one or more student models, the errors with respect to data which are included in the training examples but not included in the sampling group, and calculates an average of the errors calculated for the one or more student models.

8. An information processing method comprising:
accepting training examples formed by features;
assigning labels to the training examples;
generating one or more student models using the training examples to which the labels are assigned, and calculating errors between predictions of the one or more student models and the labels;
generating an error prediction model which is a model for predicting the errors; and
outputting each example for which the error is predicted to be significant based on the error prediction model.

9. A non-transitory computer-readable recording medium storing a program, the program causing a computer to perform a process comprising:
accepting training examples formed by features;
assigning labels to the training examples;
generating one or more student models using the training examples to which the labels are assigned, and calculating errors between predictions of the one or more student models and the labels;
generating an error prediction model which is a model for predicting the errors; and
outputting each example for which the error is predicted to be significant based on the error prediction model.
